(19) United States
(12) Patent Application Publication
(10) Pub. No.: US 2008/0196331 A1
(43) Pub. Date: Aug. 21, 2008

(54) Window frame with lip for covering windows

(76) Inventor: Thomas J. Boyd, Conroe, TX (US)

Correspondence Address: SCHUBERT OSTERRIEDER & NICKELSON PLLC, 6013 CANNON MTN DR, S14, AUSTIN, TX, 78749, US

(21) Appl. No.: 11/707,326

(22) Filed: Feb. 16, 2007

(51) Int. Cl. E06B 3/26

(52) U.S. Cl. 52/202

(57) ABSTRACT

Devices and methods are disclosed for covering one or more windows held in a window frame by receipt of a pre-formed element into a pre-formed lip integrally attached or affixed to a window frame. In one example embodiment, the device includes a window frame having a first side and a second side, wherein the first side and the second side directly oppose each other in direction with a depth therebetween. The device further includes a first side having a perimeter, and a pre-formed lip continuously disposed along at least half of the perimeter, wherein the pre-formed lip may receive a pre-formed element fitting into and retained by the pre-formed lip in order to at least substantially cover the first side of the window frame. The device may also include a groove alongside the pre-formed lip for receiving vinyl and/or shims to more securely retain the pre-formed element.

### FIELD OF INVENTION

The invention generally relates to methods and devices for covering one or more windows within a window frame, and, in particular, for covering windows held in a window frame having an integrally attached pre-formed lip that receives a pre-formed element, such as plywood or a sunscreen, in order to protect the windows from storms, provide an added security measure, or provide protection from sunlight, for example, without the use of nails or other affixing media to the building containing the window frame.

### BACKGROUND

Window frames housing one or more windows are commonplace in home and commercial environments. Normally, window frames are installed in either residential or commercial environments where a first side faces an exterior environment, i.e., the outdoors, and a directly opposing second side faces an interior environment, i.e., the indoors. However, windows frames are also installed internally within a building or residence where both the first side and the directly opposing second side face the indoors; such may be common in large commercial buildings where there are many offices on each floor of the building.

Regardless where a window frame is installed, window frames are well known as the housing unit for one of more windows, which may be composed of one or more panes. These windows may slide up, slide over, swing or roll out, etc. in order to allow the pass-through of air and/or sound into a building. One or more screens may also be held by the window frame in order to prevent bugs, for instance, from coming indoors. On the other hand, the window(s) may not open, and, instead, just allow translucence as windows that open do as well.

Windows, however, whether they are made of glass, plastic, or other materials, often are the Achilles' Heal of a building. For example, during a hurricane, tropical storm, tornado, or other storm, windows are susceptible to breakage by wind, hail, or even objects made projectiles by forces of nature. As a result, windows can break, and worse yet, invite the menacing storm into the interior of a building to wreak even more havoc on the goods and people therein. As a further example, the sun's rays that penetrate windows can damage goods within an interior of a building by bleaching them as well as increasing the air-conditioning bill, a protracted problem especially in warm weather climates. And, still by further example, misfeasors and malfeasors can often break windows easily, and, thus, windows provide a real security breach point for a building, whether residential or commercial.

Although solutions to redress the foregoing examples exist, problems remain. Typically, bolts, nails, screws, etc. are affixed to a building wall or the window frame, itself, in order to protect a window from storms, the sun, and perceived security threats. For instance, during the approach of a hurricane, coastal residents and tenants are often seen on the news screwing or nailing plywood over each and every one of a building's windows. Similarly, installation of sunscreens also usually involves nailing or screwing mounting units over a window frame in order to apply a sunscreen aimed at decreasing bleaching or reducing an air-conditioning bill. And, in regard to security devices over windows, oftentimes this involves the application of metal bars attached to a building's exterior wall or the window frame with screws or bolts. Removal of the plywood after the storm has passed, as well as removal of sunscreens or security devices leaves unsightly damage to the building's walls or window frames caused by the bolts, nails or screws. In addition, this damage also leaves a costly repair bill since it may require re-spackling, puttying, re-dry walling, re-painting, and so forth. The prior art has failed to address these problems.

Accordingly, in light of the example, above-identified problems, a need, therefore, exists for devices and methods for covering window(s) within window frames on homes and businesses without requiring any additional cost or repair when one wishes to uncover the window.

### SUMMARY OF THE INVENTION

In one example embodiment, the device includes a window frame having a first side and a second side, wherein the first side and the second side directly oppose each other in direction with a depth therebetween. The device further includes a first side having a perimeter, and a pre-formed lip continuously disposed along at least half of the perimeter, wherein the pre-formed lip may receive a pre-formed element fitting into and retained by the pre-formed lip in order to at least substantially cover the first side of the window frame. The device may also include a groove alongside the pre-formed lip for receiving vinyl and/or shims to more securely retain the pre-formed element that substantially covers the one or more windows in the window frame.

In another example embodiment, a method for covering one or more windows disposed within a window frame is disclosed. The method includes forming a lip continuously disposed along at least half of a perimeter on a first side of the window frame having the first side and a second side, wherein the first side directly opposes the second side in direction. The method further includes receiving, by the window frame, a pre-formed element into the lip, whereby, the receiving substantially covers the one or more windows disposed within the window frame. The method may also include placing one or more pieces of vinyl in a groove located both adjacent to the pre-formed lip and continuously disposed along at least half of the perimeter, the one or more pieces of vinyl additionally secures the pre-formed element within the pre-formed lip. Furthermore, this placing may include the use of shims to ensure a tight fit of the pre-formed element within the window frame.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a front-side view of an example window frame device having a quadrilateral shape with a pre-formed lip in accordance with the disclosed invention.

FIG. 2 depicts a side view of an example window frame device having a quadrilateral shape, a depth and a pre-formed lip in accordance with the disclosed invention.

FIG. 3 a front-side view of an example window frame device having a quadrilateral shape with a pre-formed lip and receiving a pre-formed element in accordance with the disclosed invention.

FIG. 4 depicts a front-side view of an example window frame device having a quadrilateral shape with a pre-formed lip and a groove for receiving vinyl in accordance with the disclosed invention.

FIG. 5 a front-side view of an example window frame device having an oval shape with a pre-formed lip in accordance with the disclosed invention.

### DETAILED DESCRIPTION OF EXAMPLE EMBODIMENTS

The following is a detailed description of example embodiments of the invention depicted with assistance and reference to the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, devices and methods for covering one or more windows in a window frame are contemplated. Windows, whether in homes or businesses, may be housed within a window frame, and may be substantially or completely covered by a pre-formed element received by a pre-formed lip integrally attached or affixed to the window frame. The pre-formed lip is disposed along or close to the perimeter of a first of two sides of the windows frame, wherein the first and second side directly oppose each other in direction leaving a depth therebetween where the window(s) reside within the window frame. By placing the transparent or non-transparent, pre-formed element, e.g., plywood, Lexgard®, plastic, metal, sunscreen, polycarbonate, etc., into the pre-formed lip, the windows within the window frame are substantially covered to prevent possible damage from storms, the sun's rays, or potential intruders without the need to place unsightly and damaging holes into the building containing the window one wishes to cover either temporarily or permanently. In addition to the pre-formed lip, another groove may optionally exist in the disclosed devices and method in order to ensure a tight fit of the pre-formed element within the pre-formed lip. For instance, the groove may receive fitted vinyl strips and/or shims to optionally ensure that the pre-formed element is snug within the pre-formed lip.

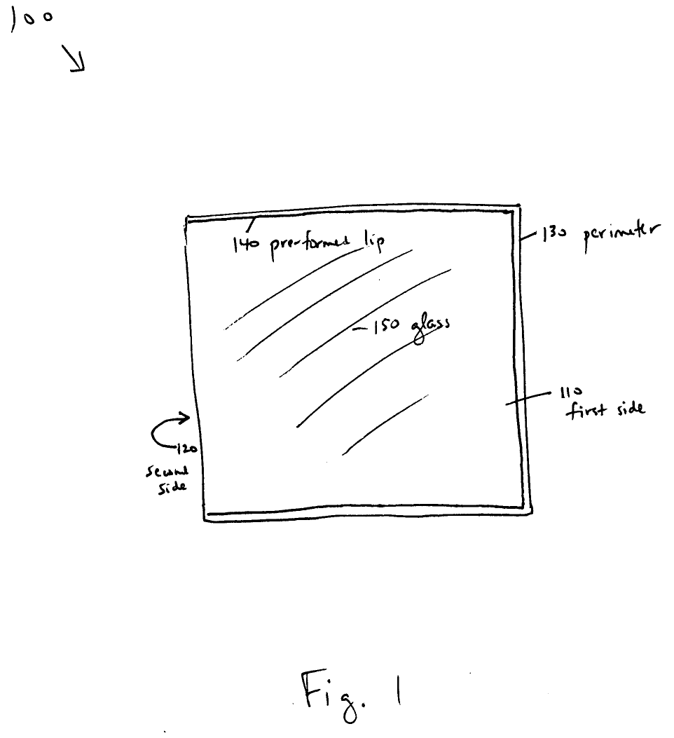

Referring now to FIG. 1, an example window frame 100 having a quadrilateral shape is depicted. In particular, FIG. 1 shows a front-side view of a window frame 100, wherein the front side is denominated as the first side 110. The second side 120 appears behind the first side 110 after a non-depicted depth is traversed if looking into FIG. 1. Oftentimes, this second side 120 also includes a window sill along the bottom of the second side 120. As is customary with window frames 100, the window frame 100 houses one or more window panes of glass 150 and/or screens. The window frame 100 is the unit that is placed in a building, whether it is a place of business or residence, in order to permit views, translucence, and/or air if the windows contained in the window unit 100 are opened if the windows contained therein 100 do indeed open at all. In this manner, the first side 110 may be exposed to an exterior environment, such as the outdoors, and the second side 120 may be interior environment, such as an air-conditioned environment of building containing the window frame 100. However, the window frame 100, without departure from the disclosed invention, may have the first and second sides 110, 120 both exposed to either interior or exterior environments. For instance, the window frame 100 may be installed within the interior of a building, and, in such an instance, both the first and second sides 110, 120 would be exposed to interior environments.

The window frame 150 also has a perimeter 130, wherein the perimeter 130, as defined herein, is located either substantially along the edges of the window frame 150 or along part of a non-depicted header portion, as the industry terms it, that frames a storefront window system. A pre-formed lip 130 is disposed continuously along at least half of this above-defined perimeter 130. Like the window frame 150, the pre-formed lip 130 may be made from metal, wood, plastic, fiberglass, or other durable substances. For instance, making the disclosed device from aluminum may involve extruding, as is known in the industry, the window frame 100, it pre-formed lip 140, and other metal components so that the pre-formed lip is integrally associated with the window frame 100. Such an aluminum window frame 100 is ideal for installation in buildings seeking a sturdy and long-lasting window frame 100. An extruded fiberglass window frame 100 may be more ideal for installation on boats, which often include a substantial portion of their construction from fiberglass. Instead of the pre-formed lip 140 being integrally attached to the window frame 100 as achieved through known extrusion or boring techniques such as those known for metal or wood substances, the pre-formed lip 140 may be affixed with screws, bolts, or nails, for instance, or even welded to a window frame 100 made from durable substance(s) such as though previously mentioned. In addition, the variety of durable substances used for the window frame 100 and its components, including the pre-formed lip 140, may have color. A colored window frame 100 may meet aesthetic desires of its sellers and/or buyers, and may be achieved, for instance, by painting the window frame 100 during or after its construction or installation, adding a selected tint during the extrusion process for forming a window frame 100 or any of its constituent parts, or be an inherent property of the substance actually used for the window frame 100.

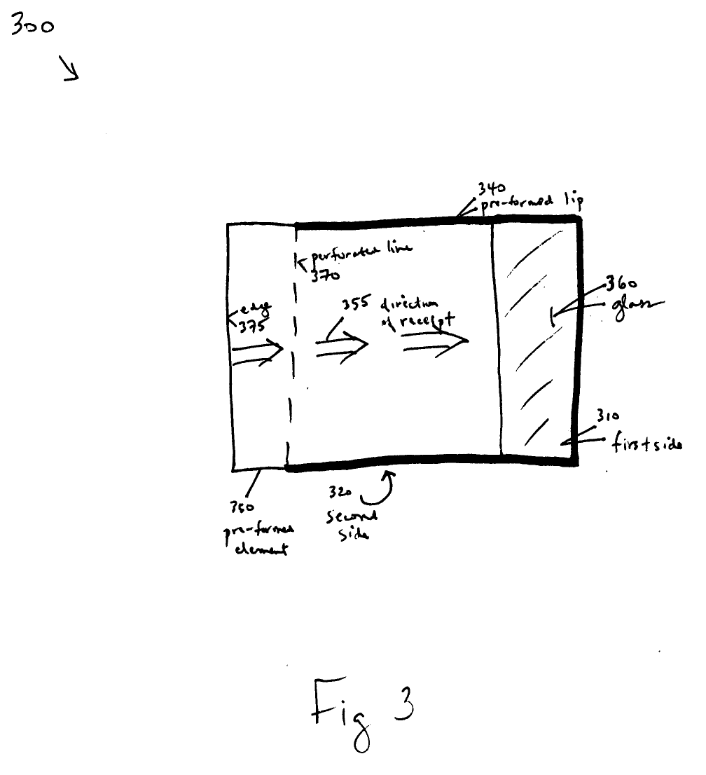

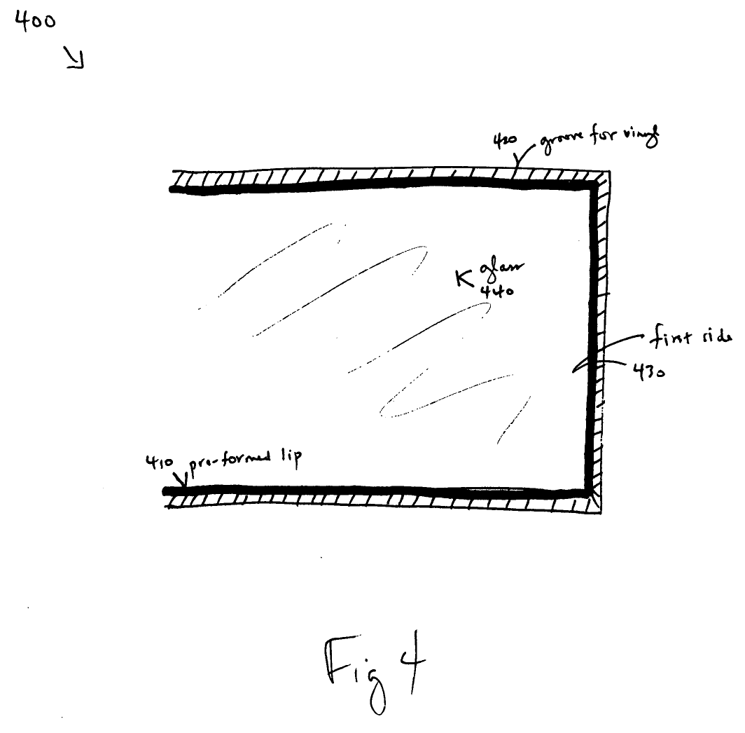

From a functional standpoint, the pre-formed lip 140 is the portion of the window frame 100 that may receive a pre-formed element that is not depicted in FIG. 1, but is depicted in FIG. 3. The pre-formed lip 140, itself, is, effectively, a combination of a groove portion for receiving a pre-formed element and a lip portion for retaining that received pre-formed element securely in place on the window frame 100. More discussion of the pre-formed lip 140 ensues with the discussion of FIGS. 3 and 4 later on in this disclosure.

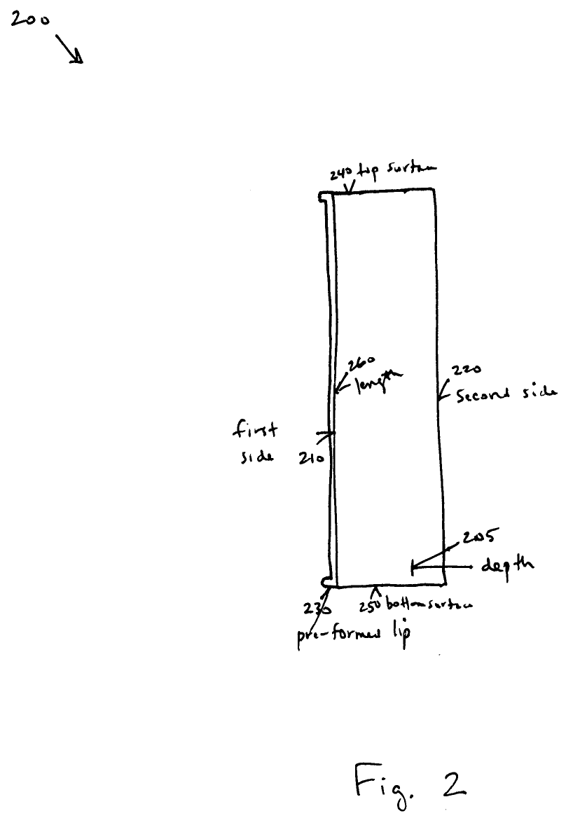

Turning now to FIG. 2, a side view of the window frame 200 is depicted. This side view shows the first side 210 and the second side 220 of the window frame 200 separated by a depth 205. This depth 205 is the portion of the window frame 200 that houses and retains the one or more panes of glass, and, optional screens. Also depicted in FIG. 2 is a different view of the pre-formed lip 230 as compared to the view depicted in FIG. 1. FIG. 2 shows the pre-formed lip 230 along the length 260 of the window frame's 200 first side 210, and the pre-formed lip 230 continues along the top and bottom surfaces 240, 250 of the first side 210; looking at FIG. 2, this would mean that the pre-formed lip 230 continues into the paper at both the top and bottom surfaces 240, 250 of the first side 210 of the window frame 200. The other, non-depicted length of the first side 210 of the window frame 200 does not contain the continuously disposed pre-formed lip 230 because, otherwise, there would be no opening for receiving a non-depicted, pre-formed element by the pre-formed lip 230.

Moving on to FIG. 3, another front-side view of the window frame 300 is depicted, but this time with a pre-formed element 360 in the process of receipt, as shown by the direction of receipt arrows 355, by the pre-formed lip 340. As shown on FIG. 1, FIG. 3 also shows a window frame 300 having a first side 310 and a second side 320 with a pre-formed lip 340. The pre-formed lip 340 is again located on and continuously disposed on at least three sides of the perimeter, as disclosed herein, of the first side 310 of the window frame 300. FIG. 3 shows the pre-formed lip 340 on the window frame 300 in the process of receiving 355 a pre-formed element 350, such as plywood, metal, plastic, sunscreen(s), Lexgard®, or other durable substance in order to cover and provide security from storms, intruders, and sunrays to the window(s) in a window frame 300, and, possibly, the contents of a building behind these window frames 300. Regardless of the substance that composes the pre-formed element 350, the shaped, pre-formed element 350 fits snugly into the receiving pre-formed lip 340. Optionally, to assist in obtaining this snug fit, FIG. 4 shows a window frame 400 having a groove 420 for receiving shaped vinyl or shims, such as neoprene gaskets, within the groove 420; this vinyl and/or shims may be pushed, clamped or otherwise placed into the groove 420. This vinyl and/or shims butts up against a pre-formed element received by pre-formed lip 410 in order to add pressure to keep the received pre-formed element snugly in place within the pre-formed lip 410. The groove 420 also is located both along the perimeter, as defined herein, of the window frame 400 and next to the pre-formed lip 410 on the first side 430.

Returning to FIG. 3 and as previously mentioned, the pre-formed lip 340 is shown to be in the process of receipt 355 of the pre-formed element 350. In addition to the arrows showing the direction of receipt 355, the window frame 300 also still shows glass 360 that is visible and retained by the window frame 300 as well as the edge 375 of the pre-formed element 350 moving towards the perforated line 370, which is a length of the window frame 300 currently obscured by the pre-formed element 350 in the process of receipt 355 by the pre-formed lip 340. Although not completely depicted, once the pre-formed element 350 is fully received by the pre-formed lip, then the edge 375 of the pre-formed element 350 will substantially align with the perforated line 370 representing a length of the window frame 300, so as to substantially cover the window(s) housed by the window frame 300. Stated again for clarity, the foregoing manner explains and shows how the pre-formed element 350 is received, whether by sliding or stabbing, for instance, into the pre-formed lip 340 of the window frame 300 in order to cover and protect the window(s) and/or screens housed and retained by the window frame 300.

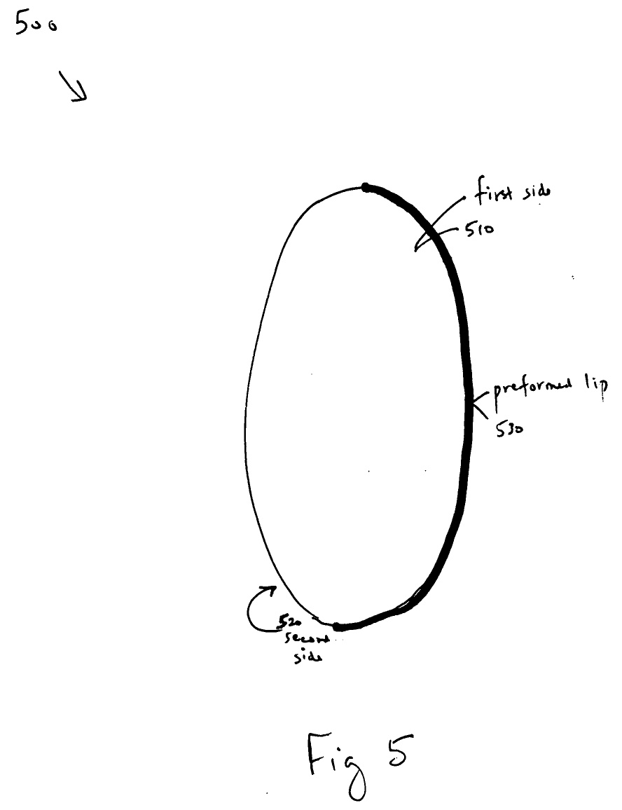

Finally, and with reference to FIG. 5, another example embodiment of the disclosed devices and methods are depicted. FIG. 5 depicts a front-side view of an oval-shaped window frame 500 having a first side 510, a second side 520, and a perforated lip 530 located on and continuously disposed on a perimeter, as defined herein, on the first side 510 of the window frame 500. Here, the perforated lip 530 is disposed only on half of the perimeter, as defined herein, of the window frame 500 because a pre-formed element for fully covering the window(s) held by the window frame 500 could not be received and retained by the pre-formed lip 530 if a single, pre-formed element traversed a path longer than half of the perimeter. A quadrilateral-shaped window frame, however, such as those shown in FIGS. 1-4, may have a pre-formed lip that traverses a path longer than half of the perimeter and is continuously disposed thereon while still receiving a single, pre-formed element in order to fully cover the window(s) housed and retained by a window frame.

While the foregoing is directed to example embodiments of the disclosed invention, other and further embodiments of the invention may be devised without departing from the basic scope thereof, and the scope thereof is determined by the claims that follow.

What is claimed is:

1. A device, comprising:
a window frame having a first side and a second side, wherein the first side and the second side directly oppose each other in direction with a depth therebetween;
the first side having a perimeter; and
a pre-formed lip continuously disposed along at least half of the perimeter, wherein the pre-formed lip may receive a pre-formed element fitting into and retained by the pre-formed lip in order to at least substantially cover the first side of the window frame.

2. The device of claim 1, wherein the pre-formed lip further comprises a groove both located adjacent to the pre-formed lip and continuously disposed along the at least half of the perimeter, wherein the groove may receive one or more pieces of vinyl to additionally secure the pre-formed element within the pre-formed lip.

3. The device of claim 2, wherein the device further comprises one or more shims located in the groove.

4. The device of claim 1, wherein one or more panes of glass are disposed within the depth of the window frame and retained by the window frame.

5. The device of claim 1, wherein the window frame houses, between the first side and the second side and within the depth, a window that opens to allow the pass-through of air.

6. The device of claim 1, wherein the window frame houses, between the first side and the second side and within the depth, a screen.

7. The device of claim 1, wherein the first side is exposed to an exterior environment.

8. The device of claim 1, wherein the second side is exposed to an interior environment.

9. The device of claim 1, wherein the window frame has a shape.

10. The device of claim 1, wherein the shape is substantially quadrilateral.

11. The device of claim 1, wherein the shape is substantially oval.

12. The device of claim 1, wherein the pre-formed element is a sunscreen.

13. The device of claim 1, wherein the pre-formed element is plywood.

14. The device of claim 1, wherein the pre-formed element is polycarbonate.

15. The device of claim 1, wherein the pre-formed element is transparent.

16. The device of claim 1, wherein the pre-formed element is non-transparent.

17. The device of claim 1, wherein the pre-formed element is a durable security substance.

18. The device of claim 1, wherein the device has a color.

19. The device of claim 1, wherein the second side has window sill.

20. The device of claim 1, wherein the window frame comprises a quadrilateral shape, wherein the pre-formed lip is continuously disposed along at least half of the perimeter comprises the pre-formed lip being continuously disposed along a first full length of the quadrilateral shape, a full width of the quadrilateral shape, and a second full length of the quadrilateral shape.

21. The device of claim 1, wherein the window frame comprises an oval shape, wherein the pre-formed lip is continuously disposed along at least half of the perimeter of the oval shape.

22. The device of claim 1, wherein the device comprises one or more extruded metals.

23. The device of claim 1, wherein the device comprises extruded fiberglass.

24. The device of claim 1, wherein the device comprises extruded plastic.

25. The device of claim 1, wherein the pre-formed lip is welded onto the perimeter of the first side.

26. The device of claim 1, wherein the pre-formed lip is affixed onto the perimeter of the first side.

27. The device of claim 26, wherein the pre-formed lip is affixed with one or more screws onto the perimeter of the first side.

28. A method for covering one or more windows disposed within a window frame, the method comprising:
forming a lip continuously disposed along at least half of a perimeter on a first side of the window frame having the first side and a second side, wherein the first side directly opposes the second side in direction; and
receiving, by the window frame, a pre-formed element into the lip; and
whereby, the receiving substantially covers the one or more windows disposed within the window frame.

29. The method of claim 28, wherein the forming comprises extruding the window frame and the lip from a durable substance.

30. The method of claim 29, wherein the durable substance comprises one or more metals.

31. The method of claim 29, wherein the durable substance comprises plastic.

32. The method of claim 29, wherein the durable substance comprises fiberglass.

33. The method of claim 28, wherein the forming comprises casting the window frame and the lip from one or more metals.

34. The method of claim 28, wherein the forming comprises welding the lip to the window frame.

35. The method of claim 28, wherein the forming comprises affixing the lip to the window frame.

36. The method of claim 28, wherein the receiving comprises sliding the pre-formed element into the lip.

37. The method of claim 28, wherein the receiving comprises stabbing the pre-formed element into the lip.

38. The method of claim 28, further comprising placing one or more pieces of vinyl in a groove located both adjacent to the pre-formed lip and continuously disposed along at least half of the perimeter, the one or more pieces of vinyl additionally secures the pre-formed element within the pre-formed lip.

39. The method of claim 38, wherein the placing comprises clamping.

40. The method of claim 38, wherein the placing comprises pushing.

41. The method of claim 38, further comprising placing one or more shims in the groove.

42. The method of claim 28, wherein the receiving by the pre-formed element protects the one or more windows disposed within the window frame from damage during a storm by the covering of the one or more windows.

43. The method of claim 28, wherein the receiving by the pre-formed element provides added security to a building having the one or more windows disposed within the window frame by the covering of the one or more windows.

44. The method of claim 28, wherein the receiving by the pre-formed element protects the one or more windows disposed within the window frame from sunlight by the covering of the one or more windows.

45. The method of claim 28, wherein the receiving comprises by one or more pieces of plywood that fit into the lip by the receiving.

46. The method of claim 28, wherein the receiving comprises by one or more sunscreens that fit into the lip by the receiving.

47. The method of claim 28, wherein the receiving comprises by one or more pieces of a durable security substance that fit into the lip by the receiving.
